(19) United States
(12) Patent Application Publication
(10) Pub. No.: US 2025/0284253 A1
(43) Pub. Date: Sep. 11, 2025

(54) Dynamic Digital Analysis of Chemical Inhibitors Utilizing Machine Learning

(71) Applicant: Saudi Arabian Oil Company, Dhahran (SA)

(72) Inventors: Taras Yurievich Makogon, Houston, TX (US); Ahmad M. Almakhaita, Dammam (SA)

(21) Appl. No.: 18/598,328

(22) Filed: Mar. 7, 2024

(51) Int. Cl. G05B 13/02

(52) U.S. Cl. CPC G05B 13/0265

(57) ABSTRACT

A computer implemented method that enables dynamic digital analysis of chemical inhibitors utilizing machine learning is described. The method includes determining a concentration output using a machine learning model trained using data associated with thermodynamic chemical inhibitors; determining temperatures associated with a chemical inhibitor regeneration cycle using a machine learning model trained using temporal data; determining a liquid inventory using a machine learning model trained using data associated with flow rates; generating a model of a chemical inhibitor regeneration cycle based on the concentration output, the temperatures, and the liquid inventory; and executing the model by inputting real-time operating conditions associated with the chemical inhibitor regeneration cycle, wherein the model outputs chemical inhibitor concentrations associated with a production system.

### TECHNICAL FIELD

This disclosure relates generally to dynamic digital analysis of chemical inhibitors utilizing machine learning.

### BACKGROUND

Chemical inhibitors are used to support hydrate management at offshore natural gas fields. Natural gas production operations can suffer from insufficient quality of chemical inhibitors. Quality of chemical inhibitors is impacted by higher than expected salinity of fluid produced from gas reservoirs.

### BRIEF DESCRIPTION OF DRAWINGS

FIG. 1 shows an architecture/workflow that enables dynamic digital analysis of chemical inhibitors utilizing machine learning.

FIGS. 2A and 2B show hydrate stability for some of the operating assets.

FIG. 3 shows gas arrival temperatures measured for several years.

FIG. 4A shows gas arrival temperatures modeled for several flow rates in asset H-2.

FIG. 4B shows gas arrival temperatures modeled for several flow rates in asset H-3.

FIG. 4C shows a first example of a graphical user interface.

FIG. 4D shows a second example of a graphical user interface.

FIG. 4E shows a third example of a graphical user interface.

FIG. 5A shows gas arrival temperatures vs hydrate condition in the asset H-2.

FIG. 5B shows arrival temperatures vs hydrate condition in the asset H-3.

FIG. 6A shows an inhibitor concentration arriving to the gas plant from the asset H-2.

FIG. 6B shows an inhibitor concentration arriving to the gas plant from the asset H-3.

FIG. 7 shows an inhibitor concentration sent to offshore from the gas plant.

FIG. 8A shows an inhibitor concentration in water arriving to the gas plant from the asset H-2.

FIG. 8B shows an inhibitor concentration required in water arriving to the gas plant from the asset H-3.

FIG. 9 shows the flow of inhibitor sent from the gas plant to offshore.

FIG. 10 shows integrated visual indicators of hydrate inhibitor concentration sent from the gas plant to offshore and received at the gas from offshore show the level of optimization.

FIG. 11 is a process flow diagram of a process that enables dynamic digital analysis of chemical inhibitors utilizing machine learning.

FIG. 12 illustrates hydrocarbon production operations that include both one or more field operations and one or more computational operations, which exchange information and control exploration for the production of hydrocarbons.

FIG. 13 is a schematic illustration of an example controller (or control system) for that enables a dynamic digital analysis of chemical inhibitors utilizing machine learning.

### DETAILED DESCRIPTION

Dynamic digital analysis of chemical inhibitors utilizing machine learning is described. The present techniques include dynamic digital analysis of chemical inhibitors including Mono Ethylene Glycol (MEG) or a Kinetic Hydrate Inhibitor (KHI). The digital analysis of chemical inhibitors quantifies the effectiveness of respective chemical inhibitors and optimizes hydrate inhibitor chemicals for natural gas production with an online solution utilizing supervised machine learning. In examples, digital Hydrate MEG and Liquids Management Solutions are used, for example, to support hydrate management at offshore sour gas fields. In embodiments, thermodynamics at gas plant operations, multiphase gas-dominated flow in production trunklines, real-time analysis of operating conditions, and predictive analysis of liquids accumulation in the lines are integrated with good accuracy, which is validated by periodic checkups and confirmed by field operations. In some embodiments, the dynamic digital analysis is performed in real-time and has a deterministic (e.g., not using a probabilistic method) predictive capability for several parameters related to inhibitor chemical quality and quantity. In some embodiments, flow software is used to train the model. The method relies on several layers of supervised machine learning, with multiple layers coupled through time.

Some advantages of the present techniques include an improved algorithm that overcomes the uncertainty of the maximum safe production rate caused by the uncertainty of regenerated chemical inhibitor quality. The present techniques enable maximizing hydrocarbon production using available chemical and/or advising how to improve the chemical quality to maximize the production. Historically, production operations suffer from insufficient quality of chemical inhibitors. In some production operations, quality is impacted by higher than expected salinity of fluid produced from gas reservoirs. The present techniques counter higher than expected salinity by using the available chemical inhibitor rather than altering the salinity of water coming with the natural gas produced from the reservoir. Additionally, the present techniques enable a reduction in carbon emissions.

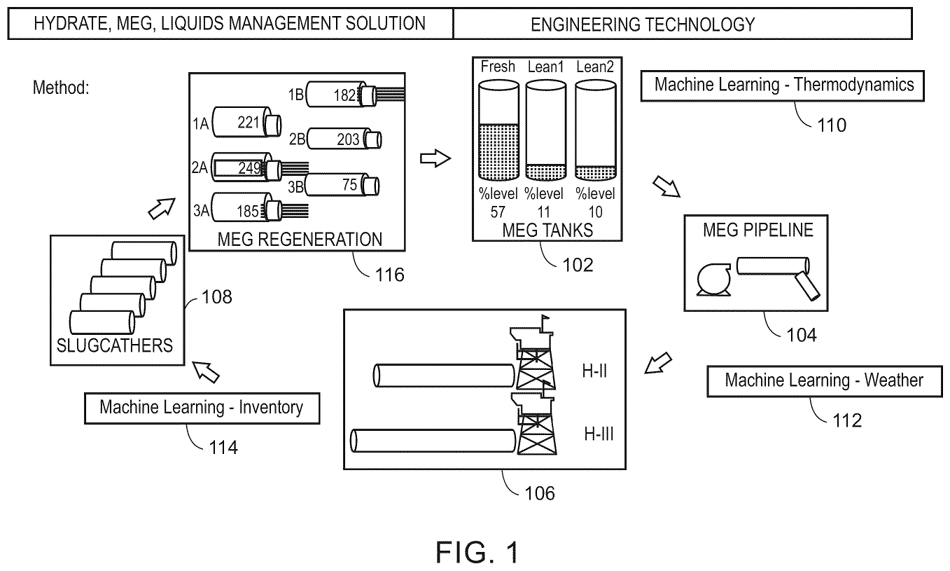

FIG. 1 shows a chemical inhibitor analysis workflow on a production system 100. The workflow is executed over a cycle of operation for chemical inhibitors including a gas plant, chemical pipeline, and produced fluid flowline (e.g., trunkline). The workflow dynamically integrates multiphase flow models, models associated with thermodynamics of inhibitor fluids in both onshore gas plant and produced fluids in offshore production systems, along with several additional aspects such as ambient environment condition, storage, mixing and in-plant piping. The models are combined with a real-time acquisition of data from plant instrumentation where several dozens of data streams are filtered and analyzed to serve as dynamic inputs into a calculation model that ensures that the chemical inhibitor is of sufficient quality. Historical data is stored to track the concentration of chemical inhibitors in the whole production system as illustrated in FIG. 1.

Predictive analysis is implemented using machine learning. Specifically, the present techniques use supervised machine learning where several data sets, sometimes limited, are used to train a model for appropriate responses to various combinations of multiple parameter inputs. In FIG. 1, multiple machine learning models are shown. Several supervised machine learning models are trained to output separate correlations for weather, multiphase flow, and chemical regeneration thermodynamics (with account for both pressure and salinity), and encompasses the whole cycle of the operation including Gas Plant, Chemical pipeline, and Produced fluid flowline (trunkline).

Integration of the supervised machine learning models, which are the specialized correlations not available otherwise, into the method is coupled through time. Specific time steps, between 2 minutes and 2 days, preferably 2 hours, are taken to integrate parameters, and update the state of the system. Integration steps 110-114 are illustrated in FIG. 1.

As shown in FIG. 1, the workflow begins at reference number 102 where chemical tanks are shown. The amount of liquid in the tanks and the concentration of a chemical inhibitor in water is measured or estimated for each tank. This value is automatically iteratively improved over time until it reaches the actual operating values. The tanks may contain mixtures of one or more concentrations. This is accounted for by keeping track of each tank individually, for both chemical quantities and concentrations.

The workflow progresses to reference number 104 where a chemical pipeline is shown. The flow into the chemical pipeline is controlled by an actual setting of the pump at the chemical facility. An operator obtains a value for the pump flow rate to accommodate the current and anticipated weather, chemical plant performance, and the OSPAS-prescribed gas production rate, to meet the predetermined standard to remain outside the hydrate risk condition by a prescribed temperature margin.

The workflow progresses to reference number 106 where production pipelines are shown. In an example, two or more production pipelines are used to carry produced fluid from an offshore platform to the onshore process equipment. The produced fluid can include sour gas fluids. Multiple parameters such as flow, temperature, pressure, liquid velocity, gas velocity are used for multiphase flow assurance. The parameters are reflected in a machine learning model. A machine learning model 112 that is trained on temporal data generates temperatures associated with a chemical inhibitor regeneration cycle. A machine learning model 114 that is trained on data associated with flow rates generates a liquid inventory that described the liquid content in the production pipelines. In this implementation, the machine learning models for weather condition 112 and for liquid content 114 in the production pipelines are integrated in the model of the chemical inhibitor regeneration cycle.

The workflow progresses to reference number 108, where inlet separators and slugcatchers are shown. Produced fluid arriving from the production system, in this implementation, from one or two pipelines, are tracked by the model. The conditions of their arrival include temperature and pressure of the produced fluid, and chemical concentration present in the fluid represent the focal point of the method. Thermodynamic analysis based on statistical thermodynamics is used to estimate the risk of gas hydrate solid stability, which is compared against the conditions in the inlet separators. In examples, for the prediction of hydrate formation conditions (P, T), a van der Waals-Platteeuw (VdW-P) model based on statistical thermodynamics is used. The VdW-P model approach uses arbitrary reference parameters obtained from a regression analysis of data associated with arrival of the produced fluid. In some embodiments, an operator is advised in real time whether the risk of hydrate solid blockage exists, and advised on the rate at which gas can be produced so that the risk of hydrate blockage is mitigated by the available chemical inhibitor present in the fluid.

The workflow progresses to reference number 116, where chemical regeneration is shown. A liquid stream separated in the inlet separator is routed to the chemical regeneration process. An additional machine learning model 110, trained using data associated with thermodynamic chemical inhibitors, is used to calculate the product chemical concentration.

At each of reference numbers 110, 112, and 114, layers of machine learning and analytics of historic operational data along with state-of-the-art hydraulics and thermodynamic simulation software are implemented to optimize chemical inhibitor injection and well production. The present techniques manage hydrate risk and forecast pipeline liquids content and provide relevant information to the operations user. The solution has several layers of robustness built in, so if one or more data streams are unavailable or corrupt, the model readjusts the values obtained by a redundant method.

The hydrate risk is mitigated by injection of the chemical inhibitor from onshore facilities. The chemical inhibitor is recycled and reused in the production system. The recycling or regeneration system for the chemical inhibitor takes place in an onshore plant and involves removal of produced water and impurities such as salt. Impurities may accumulate in the chemical inhibitor. However, when the salt content of produced fluids exceeds the regeneration units' capacity to remove the salt, salt can remain dissolved and accumulate in the aqueous chemical inhibitor mixture. The chemical inhibitor is regenerated by application of heat to boil off the produced water in reboilers. Concentrated or “lean” chemical inhibitor is reused to protect produced fluids from gas hydrates. High salt content results in a reduced quality of regenerated chemical inhibitor.

As part of mitigating the hydrate risk through the injection of glycol, the chemical inhibitor is regenerated by applying heat to boil off the produced water and to recover the concentrated chemical inhibitor for reuse. A supervised machine learning model is used to predict the regenerated chemical inhibitor quality based on reboiler temperature and several other parameters.

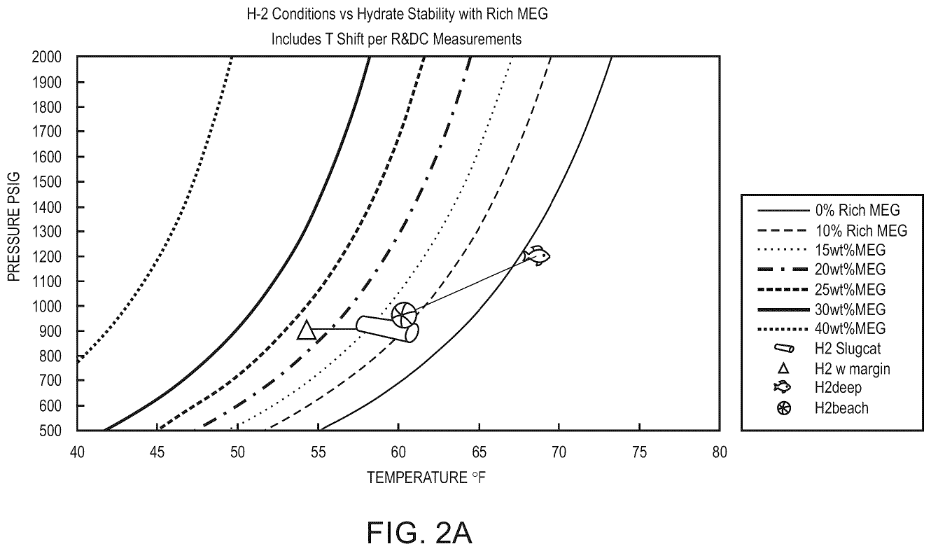

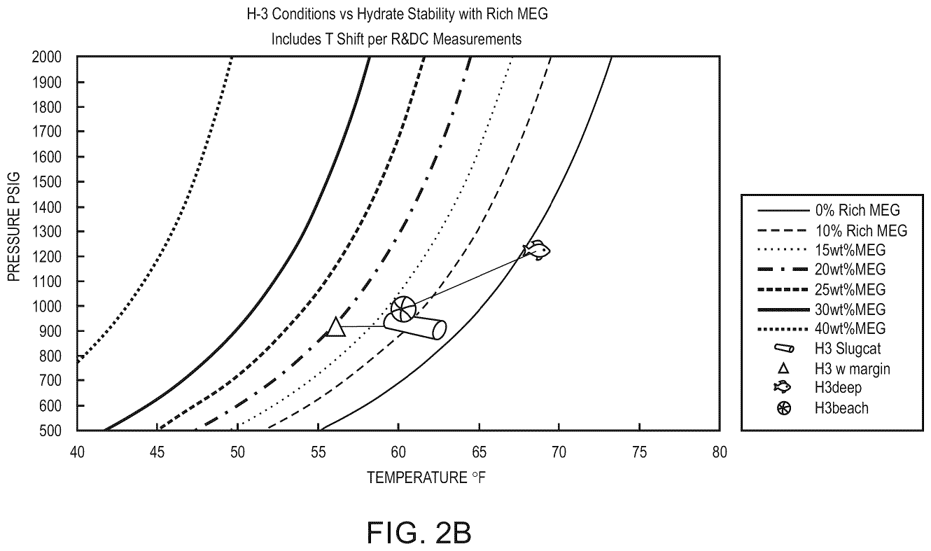

It was determined, through laboratory measurements, that hydrate stability predicted by commercial software for sour gas fluids containing H2S and CO2 can be optimistic. The deviation in prediction by commercial software from the measured hydrate stability condition increases with the increasing chemical inhibitor concentration in the aqueous phase. In some embodiments, differences in commercial software prediction and in laboratory measured data serve as a basis for the one part of subsequent thermodynamic analysis. The difference between a software prediction and in laboratory measurement at the same or nearest inhibitor concentration can be used to calibrate (i.e., shift) software predictions at other conditions. Accurate hydrate stability conditions are determined for a range of chemical concentrations. Determining accurate hydrate stability conditions is important because gas hydrate can create operational and process safety issues if a hydrate blockage is formed. FIGS. 2A and 2B illustrate the hydrate stability for some of the operating assets H-2 and H-3 where the present techniques were deployed.

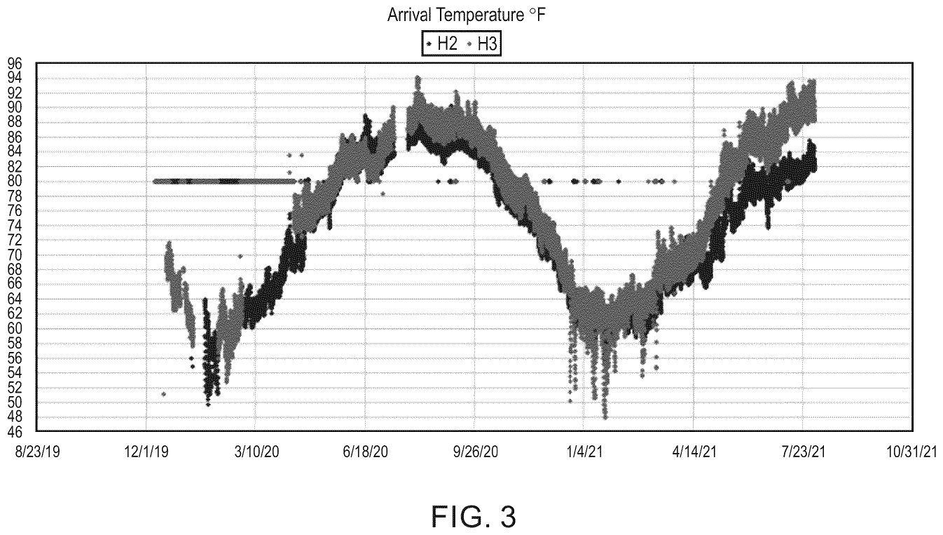

FIG. 2A shows asset H-2 conditions as compared to hydrate stability for asset H-2. The H-2 Slugcat point represents an onshore slugcatcher condition. The H-2 w margin represents the same with a 5° F. margin added for variability of operating conditions. H-2 Deep represents a condition subsea near the platform, after gas cooldown to ambient subsea condition. The H-2 Beach represents condition at onshore landing. The subsea and beach conditions are both measured and modeled with supervised machine learning, based on historical data similar to those illustrated in FIG. 3. FIG. 3 shows gas arrival temperatures measured for several years.

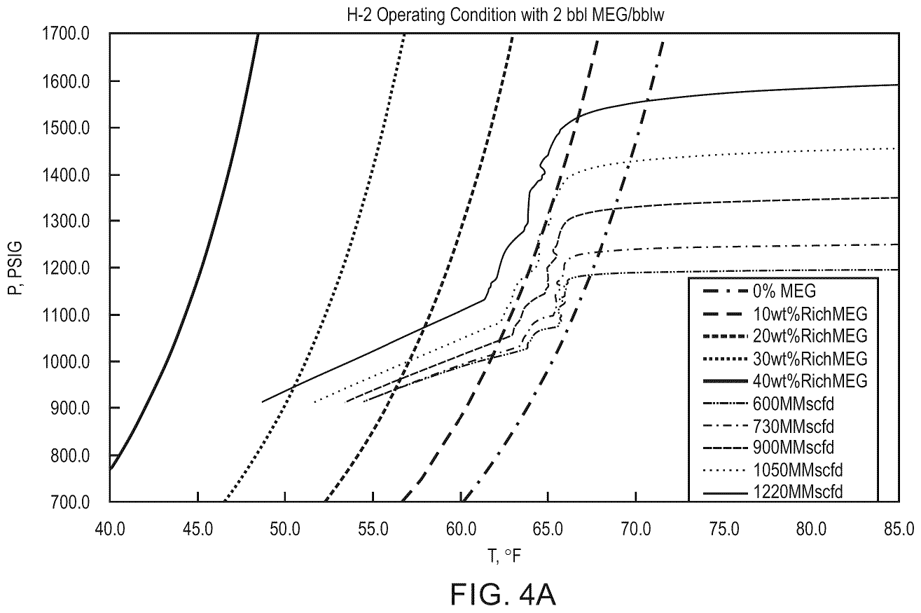

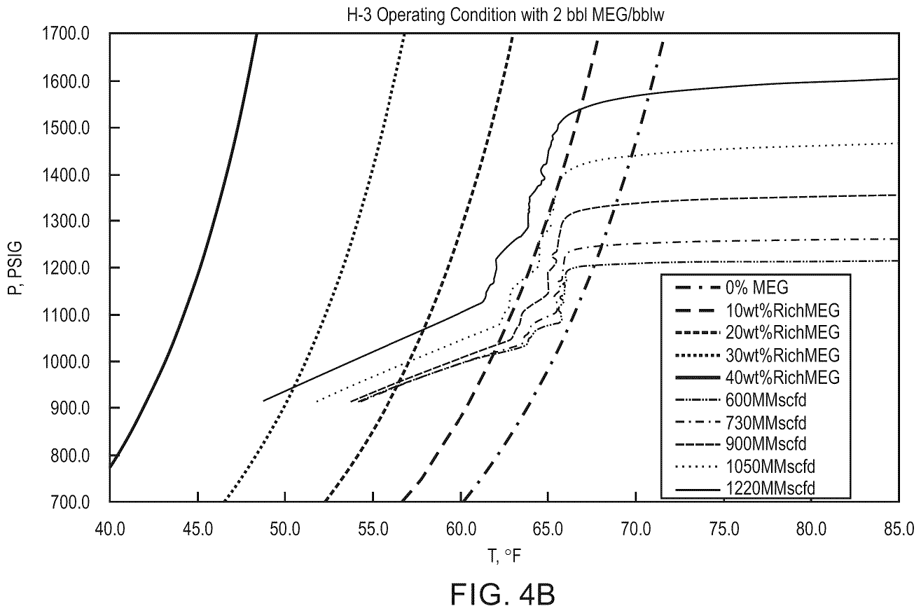

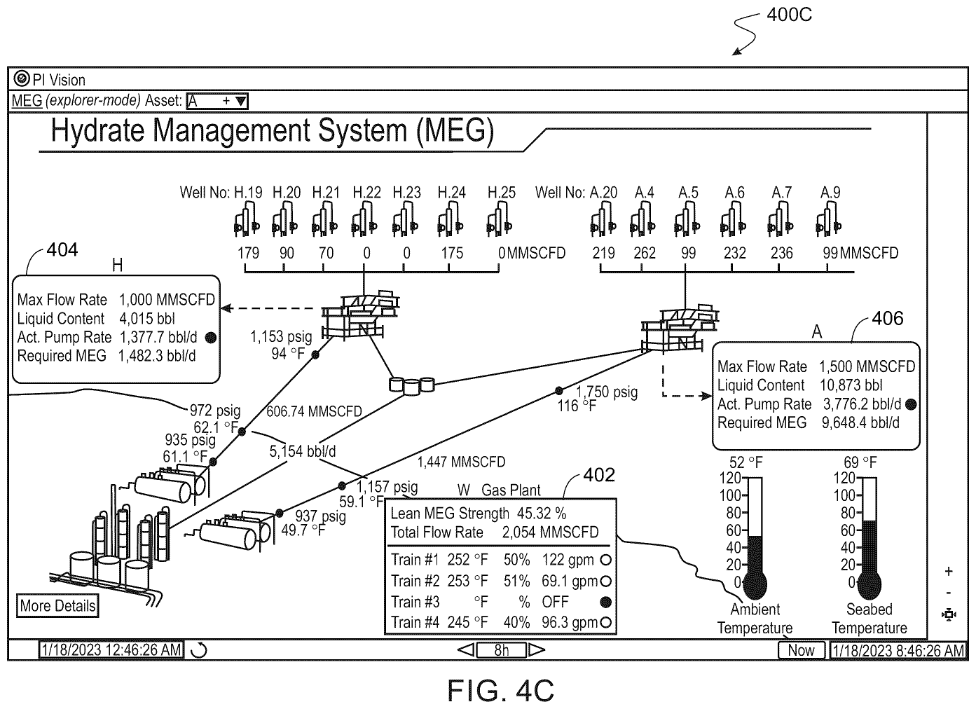

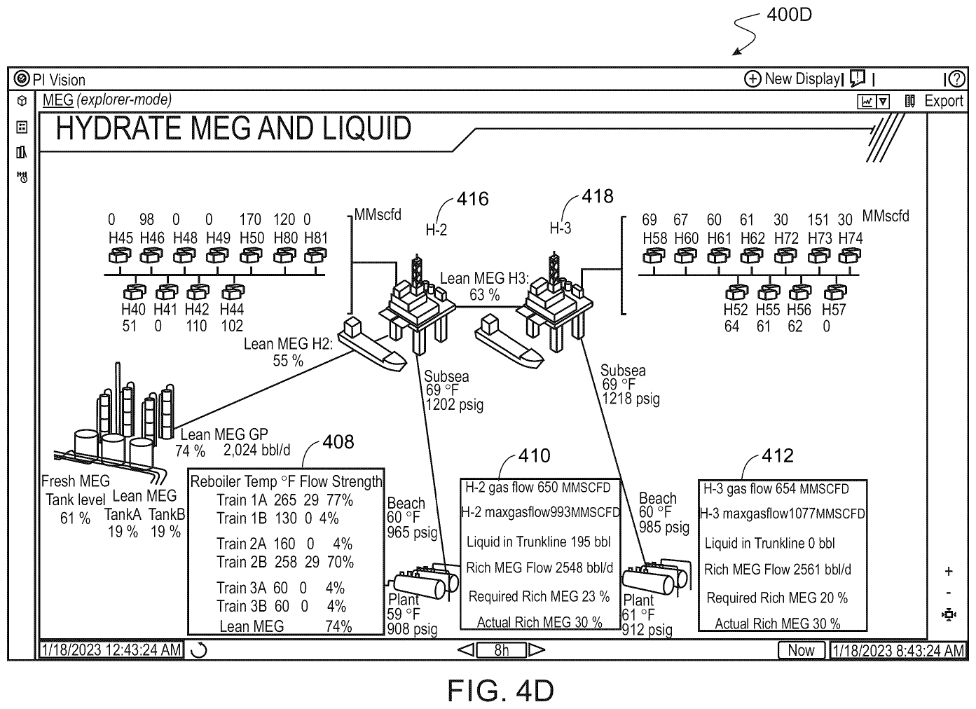

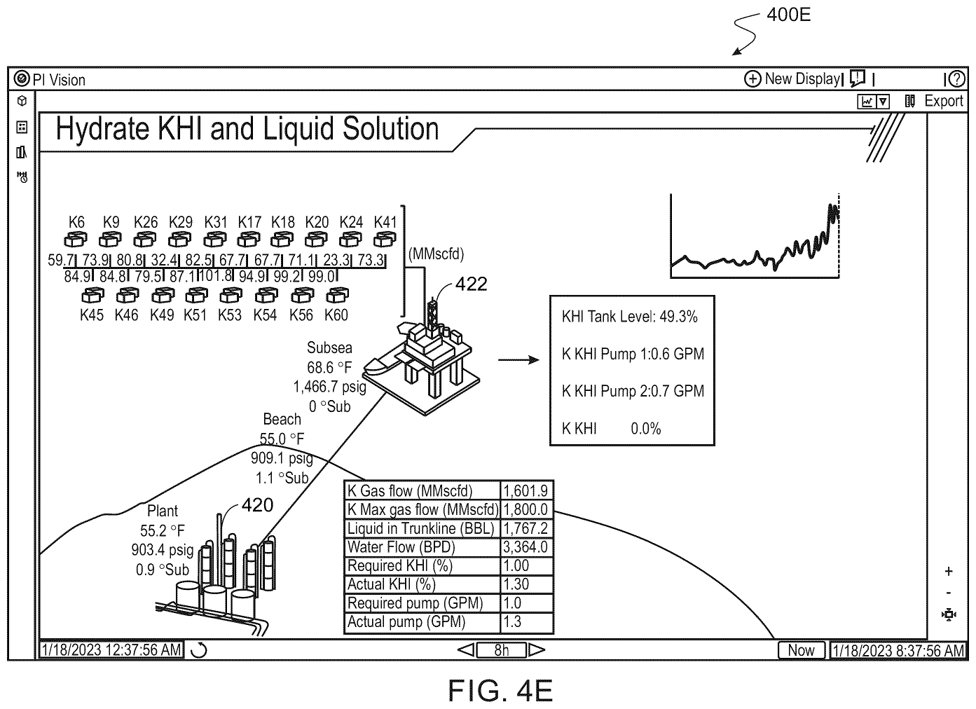

FIG. 4A shows gas arrival temperatures modeled for several flow rates in asset H-2. The gas arrival temperatures show operating conditions for the asset H-2 and the inhibitor requirement for the condition at each temperature. The actual measured operating condition or the operating condition modeled with machine learning correlation determines the inhibitor required for the condition.

FIG. 4B shows gas arrival temperatures modeled for several flow rates in asset H-3. The gas arrival temperatures show operating conditions for the asset H-3 and the inhibitor requirement for the condition at each temperature. The actual measured operating condition or the operating condition modeled with machine learning correlation determines the inhibitor required for the condition.

FIG. 4C shows a first example of a graphical user interface 400C. In the example of FIG. 4C, real-time operating conditions associated with the chemical inhibitor regeneration cycle between a gas plant 402, asset H 404, and asset A 406 are captured and input into a model that outputs chemical inhibitor concentrations. Asset H 404 and asset A 406 are interconnected via a pipeline network to the gas plant 402. Asset H 404 is connected to several wells, such as H.19, H.20, H.21, H.22, H.23, H.24, and H.25. Similarly, asset A 406 is connected to several wells, such as A.20, A.4, A.5, A.6, A.7, and A.9. As shown in FIG. 4C, each well produces at a respective Million Standard Cubic Feet per Day of gas (MMSCFD). The gas plant 402 operates at the indicated MMSCFD and Lean MEG Strength. In some embodiments, a model of the of a chemical inhibitor regeneration cycle is generated based on the concentration output, the temperatures, and the liquid inventory associated with assets 404 and 406. The model outputs chemical inhibitor concentrations associated with a production system, such as chemical inhibitor concentrations associated with gas plant 402, asset H 404, and asset A 406, or any combinations thereof.

FIG. 4D shows a second example of a graphical user interface 400D. In the example of FIG. 4D, real-time operating conditions associated with the chemical inhibitor regeneration cycle between a Lean MEG gas plant 408, plant 410, plant 412, offshore field H-2 416, and offshore field H-3 418. Offshore field H-2 416 and offshore field H-3 418 are interconnected via a pipeline network to the Lean MEG gas plant 408, gas plant 410, and gas plant 412 as shown. Offshore field H-2 416 includes a number of interconnected treatment facilities, such as facilities H40, H41, H42, H44, H45, H46, H48, H49, H50, H80, and H81. Offshore field H-3 418 includes a number of interconnected treatment facilities, such as facilities H52, H55, H56, H57, H58, H60, H61, H62, H72, H73, and H74. As shown in FIG. 4D, each facility produces at a respective MMSCFD of gas. The Lean MEG gas plant 408, gas plant 410, and gas plant 412 operate at the indicated MMSCFD and Lean MEG Strength. In some embodiments, a model of the of a chemical inhibitor regeneration cycle is generated based on the concentration output, the temperatures, and the liquid inventory associated with offshore field H-2 416 and offshore field H-3 418. The model outputs chemical inhibitor concentrations associated with a production system, such as chemical inhibitor concentrations associated with Lean MEG gas plant 408, plant 410, plant 412, offshore field H-2 416, and offshore field H-3 418, or any combinations thereof.

FIG. 4E show a third example of a graphical user interface 400E. In the example of FIG. 4E, real-time operating conditions associated with the chemical inhibitor regeneration cycle between a gas plant 420 and an offshore field K 422 are captured and input into a model that outputs chemical inhibitor concentrations. Offshore field K 420 is interconnected via a pipeline network to the gas plant 420 as shown. Offshore field K 420 includes a number of interconnected treatment facilities, such as facilities K6, K9, K26, K29, K31, K17, K18, K20, K24, K41, K45, K46, K49, K51, K53, K54, K56, and K60. As shown in FIG. 4E, each facility produces at a respective MMSCFD of gas. The gas plant 420 operates at the indicated MMSCFD and Lean MEG Strength. In some embodiments, a model of the of a chemical inhibitor regeneration cycle is generated based on the concentration output, the temperatures, and the liquid inventory associated with offshore field K 420. The model outputs chemical inhibitor concentrations associated with a production system, such as chemical inhibitor concentrations associated with offshore field K 420, gas plant 420, or any combinations thereof.

In examples, the graphical interfaces 400C, 400D, and 400E each show shows the production from individual offshore wellhead platforms or facilities, maximum production flow rate based on the available chemical, the liquid content in each trunkline which is used by the operations for maintenance scraping planning. Additional information includes current conditions along each production subsea trunkline near the platform, at the beach and near the plant inlet area, the hydrate inhibitor chemical regeneration quality, and the chemical flow rate. In case of the kinetic hydrate inhibitor (KHI) low dosage hydrate inhibitor (LDHI) use shown in FIG. 4E, the dynamically calculated subcooling conditions are shown along the production trunkline at subsea, beach and plant locations. In examples, calculated cooling conditions are shown at onshore fields, offshore fields, and gas plants. Additional information may be displayed, as custom-made for each operating facility.

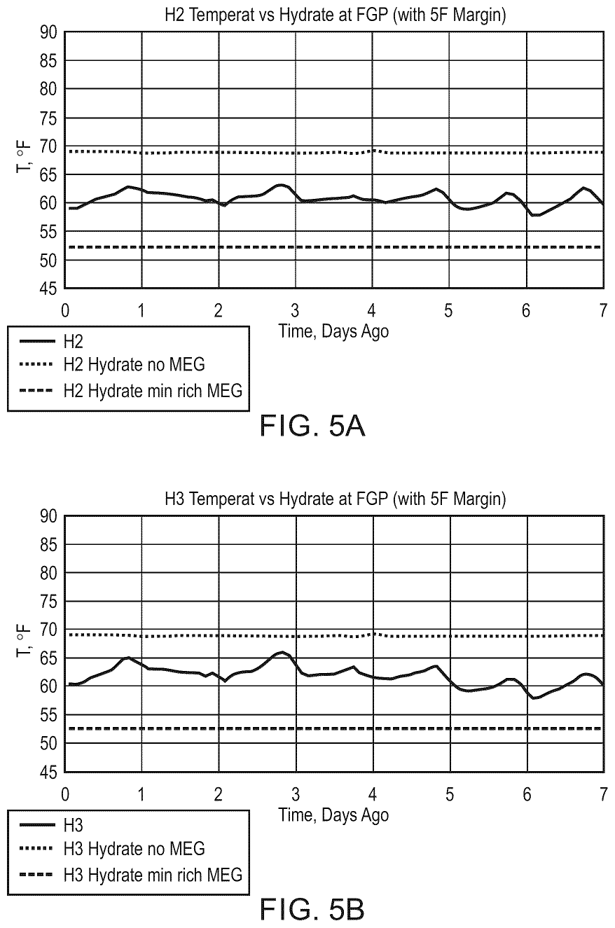

FIG. 5A shows gas arrival temperatures vs hydrate condition in the asset H-2. Similarly, FIG. 5B shows arrival temperatures vs hydrate condition in the asset H-3.

The present techniques are robust to be implemented in temperature conditions from Arctic −50° C. to Arabic +50° C. The environment conditions may reach fairly cold temperatures, in the 40-50° F. range as shown in FIGS. 5A and 5B. FIG. 5A shows gas arrival temperatures vs hydrate condition in the asset H-2. FIG. 5B shows arrival temperatures vs hydrate condition in the asset H-3. The multiphase models accurately reflect the temperatures for gas arrival to the gas plant, validating the operating conditions with field measurements over several years. These data served for developing one of the layers of a supervised machine learning correlation. Machine learning is used to create the multi-phase models of several key parameters at several key locations (e.g., subsea, beach, and plant). Parameters include fluid temperature and a content of liquid during multiphase flow in the pipeline segment.

Operating conditions were modeled in a commercial multiphase flow software and thermodynamic software to establish the operational need for a certain range of hydrate inhibitor concentrations in the produced fluids, depending on the operating conditions, as shown in FIGS. 4A and 4B. The operational need is to reduce the chemical inhibitor concentration relative to a fixed value. This allows the software to dynamically determine the minimum acceptable inhibitor concentration. As the system has multiple parameters, some of which cannot be measured (e.g., seawater temperature, inhibitor concentration in the plant inhibitor regeneration process, etc.), machine learning is used to provide reliable predictions of these parameters that cannot be measured.

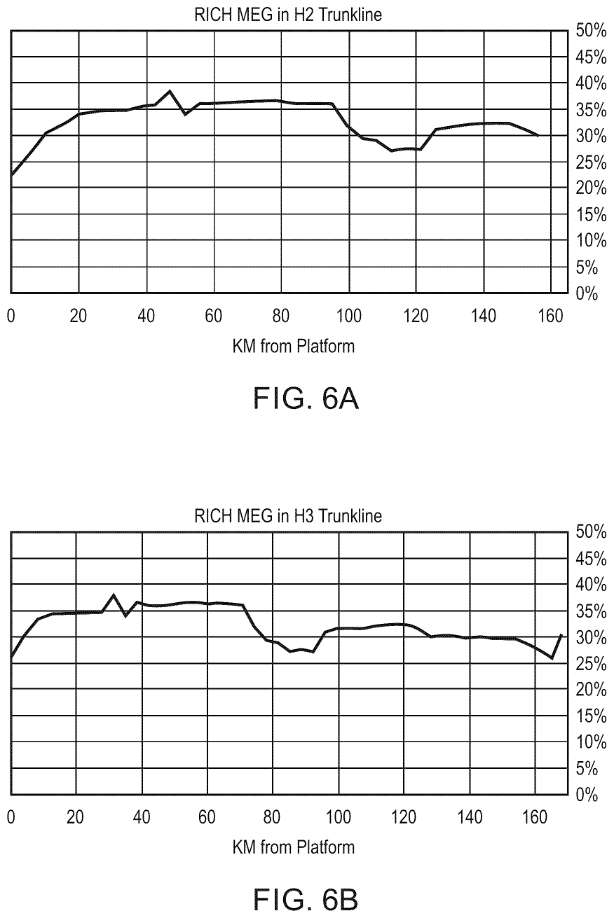

FIG. 6A shows an inhibitor concentration arriving to the gas plant from the asset H-2. The concentration of RICH MEG along the pipeline for the asset H-2 is shown.

The following step-by-step formulas calculate the required volumetric flowrate of Regenerated MEG pump flow from an onshore facility which receives the produced fluids (a mixture of hydrocarbons, both gaseous and liquid condensate and aqueous mixture of MEG) from the subsea pipelines from A (an offshore platform) and from H (another offshore platform), given the quality is known:

$$CONC = \frac{{m}_{MEG}}{{m}_{MEG} + {m}_{WAT} + {m}_{RESWAT}}$$

$${m}_{MEG} = {REG}_{MEG} \times QUAL$$

$$CONC = \frac{{REG}_{MEG} \times QUAL}{{m}_{MEG} + {m}_{WAT} + {m}_{RESWAT}}$$

$${REG}_{MEG} = {m}_{MEG} + {m}_{WAT}$$

$$CONC = \frac{{REG}_{MEG} \times QUAL}{{REG}_{MEG} + {m}_{RESWAT}}$$

$${REG}_{MEG} = \frac{CONC \times {m}_{RESWAT}}{QUAL - CONC}$$

$${\dot{V}}_{REG MEG} = \frac{{\dot{m}}_{MEG}}{{ρ}_{MEG}} + \frac{{\dot{m}}_{WAT}}{{ρ}_{WAT}}$$

$${\dot{V}}_{REG MEG} = \frac{CONC \times {m}_{RESWAT}}{QUAL - CONC} \times ( \frac{QUAL}{{ρ}_{MEG}} + \frac{1 - QUAL}{{ρ}_{WAT}} )$$

### Where:

QUAL: Lean MEG wt % in total fluid inside MEG Pipeline.
CONC: Rich MEG wt % in total fluid inside Gas trunkline.
REG_{MEG}: Lean MEG mass flowrate.
\dot{V}_{REG MEG}: Lean MEG volumetric flowrate.
\dot{m}MEG: Mass flowrate of MEG in REG_{MEG}.
\dot{m}_{WAT}: Mass flowrate of Water in REG_{MEG}.
\dot{m}_{RESWAT}: Mass flowrate of water from the reservoir.
Q_{Pump}: Volumetric Flowrate of REG_{MEG} pump from the onshore facility
ρ_{MEG}: Density of MEG
ρ_{WAT}: Density of Water

The following step-by-step formulas calculate the minimum required Lean MEG Quality of Regenerated MEG pump flow from the onshore facility:

$$CONC = \frac{{\dot{m}}_{MEG}}{{\dot{m}}_{MEG} + {\dot{m}}_{WAT} + {\dot{m}}_{RESWAT}}$$

$${\dot{m}}_{MEG} = {REG}_{MEG} \times QUAL$$

$$CONC = \frac{{REG}_{MEG} \times QUAL}{{\dot{m}}_{MEG} + {\dot{m}}_{WAT} + {\dot{m}}_{RESWAT}}$$

$${REG}_{MEG} = {\dot{m}}_{MEG} + {\dot{m}}_{WAT}$$

$$CONC = \frac{{REG}_{MEG} \times QUAL}{{REG}_{MEG} + {\dot{m}}_{RESWAT}}$$

$${REG}_{MEG} = \frac{{Q}_{Pump}}{\frac{QUAL}{{ρ}_{MEG}} + \frac{1 - QUAL}{{ρ}_{WAT}}}$$

$$CONC = \frac{\frac{{Q}_{Pump}}{\frac{QUAL}{{ρ}_{MEG}} + \frac{1 - QUAL}{{ρ}_{WAT}}} \times QUAL}{\frac{{Q}_{Pump}}{\frac{QUAL}{{ρ}_{MEG}} + \frac{1 - QUAL}{{ρ}_{WAT}}} + {\dot{m}}_{RESWAT}}$$

$$QUAL = \frac{\frac{{Q}_{Pump}}{\frac{QUAL}{{ρ}_{MEG}} + \frac{1 - QUAL}{{ρ}_{WAT}}} \times QUAL}{\frac{{Q}_{Pump}}{\frac{QUAL}{{ρ}_{MEG}} + \frac{1 - QUAL}{{ρ}_{WAT}}} + {\dot{m}}_{RESWAT}} ( 1 + \frac{{\dot{m}}_{RESWAT}}{{REG}_{MEG}} )$$

$$QUAL = \frac{\frac{{Q}_{Pump}}{{\dot{m}}_{R ESWAT}} + \frac{1}{{ρ}_{WAT}}}{\frac{{Q}_{Pump}}{{\dot{m}}_{RESWAT} \times CONC} + \frac{1}{{ρ}_{WAT}} - \frac{1}{{ρ}_{MEG}}}$$

### Where

QUAL: Lean MEG wt % in total fluid inside MEG Pipeline.
CONC: Rich MEG wt % in total fluid inside Gas trunkline.
REG_{MEG}: Lean MEG mass flowrate.
\dot{m}_{MEG}: Mass flowrate of MEG in REG_{MEG}.
\dot{m}_{WAT}: Mass flowrate of Water in REG_{MEG}.
\dot{m}_{RESWAT}: Mass flowrate of water from the reservoir.
Q_{Pump}: Volumetric Flowrate of REG_{MEG} pump from the onshore facility
ρ_{MEG}: Density of MEG
ρ_{WAT}: Density of Water

The following step-by-step formulas calculate the make-up volumetric flowrate of MEG needed to be injected at the onshore facility, in addition to the maximum Regenerated MEG pump flow:

$$CONC = \frac{{\dot{m}}_{MEG} + {\dot{m}}_{Fresh MEG}}{{\dot{m}}_{MEG} + {\dot{m}}_{Fresh MEG} + {\dot{m}}_{WAT} + {\dot{m}}_{RESWAT}}$$

$${\dot{m}}_{MEG} = {REG}_{MEG} \times QUAL$$

$$CONC = \frac{{REG}_{MEG} \times QUAL + {\dot{m}}_{Fresh MEG}}{{\dot{m}}_{MEG} + {\dot{m}}_{Fresh MEG} + {\dot{m}}_{WAT} + {\dot{m}}_{RESWAT}}$$

$${REG}_{MEG} = {\dot{m}}_{MEG} + {\dot{m}}_{WAT}$$

$$CONC = \frac{{REG}_{MEG} \times QUAL + {\dot{m}}_{Fresh MEG}}{{\dot{m}}_{Fresh MEG} + {REG}_{MEG} + {\dot{m}}_{RESWAT}}$$

$${REG}_{MEG} = \frac{{Q}_{Pump}}{\frac{QUAL}{{ρ}_{MEG}} + \frac{1 - QUAL}{{ρ}_{WAT}}}$$

$${\dot{m}}_{Fresh MEG} = \frac{\frac{{Q}_{Pump}}{\frac{QUAL}{{ρ}_{MEG}} + \frac{1 - QUAL}{{ρ}_{WAT}}} \times ( CONC - QUAL ) + CONC \times {\dot{m}}_{RESWAT}}{1 - CONC}$$

$${\dot{V}}_{Fresh MEG} = \frac{{\dot{m}}_{Fresh MEG}}{{ρ}_{MEG}}$$

$${\dot{V}}_{Fresh MEG} = \frac{\frac{{Q}_{Pump} \times ( CONC - QUAL )}{\frac{QUAL}{{ρ}_{MEG}} + \frac{1 - QUAL}{{ρ}_{WAT}}} + CONC \times {\dot{m}}_{RESWAT}}{( 1 - CONC ) \times {ρ}_{MEG}}$$

### Where

QUAL: Lean MEG wt % in total fluid inside MEG Pipeline.
CONC: Rich MEG wt % in total fluid inside Gas trunkline.
REG_{MEG}: Lean MEG mass flowrate.
\dot{m}_{MEG}: Mass flowrate of MEG in REG_{MEG}.
\dot{m}_{WAT}: Mass flowrate of Water in REG_{MEG}.
\dot{m}_{RESWAT}: Mass flowrate of water from the reservoir.
\dot{m}_{Fresh MEG}: Mass flowrate of needed Fresh MEG injected at Beach Valve Station
\dot{V}_{Fresh MEG}: Volumetric flowrate of needed Fresh MEG injected at Beach Valve Station
Q_{Pump}: Volumetric flowrate of REG_{MEG} pump from the onshore facility
ρ_{MEG}: Density of MEG
ρ_{WAT}: Density of Water

The following step-by-step formulas calculate the volumetric flowrate of MEG needed to be the onshore facility MEG Regeneration Pump if there is a maximum injection of supplemental MEG at the beach valve:

$$CONC = \frac{{\dot{m}}_{MEG} + {\dot{m}}_{Fresh MEG}}{{\dot{m}}_{MEG} + {\dot{m}}_{Fresh MEG} + {\dot{m}}_{WAT} + {\dot{m}}_{RESWAT}}$$

$${\dot{m}}_{MEG} = {REG}_{MEG} \times QUAL$$

$$CONC = \frac{{REG}_{MEG} \times QUAL + {\dot{m}}_{Fresh MEG}}{{\dot{m}}_{MEG} + {\dot{m}}_{Fresh MEG} + {\dot{m}}_{WAT} + {\dot{m}}_{RESWAT}}$$

$${REG}_{MEG} = {\dot{m}}_{MEG} + {\dot{m}}_{WAT}$$

$$CONC = \frac{{REG}_{MEG} \times QUAL + {\dot{m}}_{Fresh MEG}}{{\dot{m}}_{Fresh MEG} + {REG}_{MEG} + {\dot{m}}_{RESWAT}}$$

$${REG}_{MEG} = \frac{{Q}_{Pump}}{\frac{QUAL}{{ρ}_{MEG}} + \frac{1 - QUAL}{{ρ}_{WAT}}}$$

$${REG}_{MEG} = \frac{{\dot{m}}_{Fresh MEG} \times ( CONC - 1 ) + CONC \times {\dot{m}}_{RESWAT}}{QUAL - CONC}$$

$${\dot{V}}_{REG MEG} = \frac{{\dot{m}}_{Fresh MEG} \times ( CONC - 1 ) + CONC \times {\dot{m}}_{RESWAT}}{QUAL - CONC} \times ( \frac{QUAL}{{ρ}_{MEG}} + \frac{1 - QUAL}{{ρ}_{WAT}} )$$

### Where

QUAL: Lean MEG wt % in total fluid inside MEG Pipeline.
CONC: Rich MEG wt % in total fluid inside Gas trunkline.
REG_{MEG}: Lean MEG mass flowrate.
\dot{V}_{REG MEG}: Needed Lean MEG volumetric flowrate.
\dot{m}MEG: Mass flowrate of MEG in REG_{MEG}.
\dot{m}WAT: Mass flowrate of Water in REG_{MEG}.
\dot{m}_{RESWAT}: Mass flowrate of water from the reservoir.
\dot{m}_{Fresh MEG}: Mass flowrate of needed Fresh MEG injected at Beach Valve Station
Q_{Pump}: Volumetric flowrate of REG_{MEG} pump from the onshore facility
ρ_{MEG}: Density of MEG
ρ_{WAT}: Density of Water

FIG. 6B shows an inhibitor concentration arriving to the gas plant from the asset H-3. The concentration of RICH MEG along the pipeline for the asset H-3 is shown.

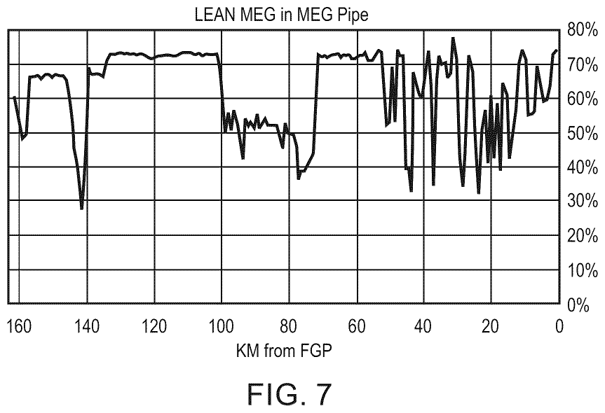

FIG. 7 shows an inhibitor concentration sent to offshore from the gas plant. The inhibitor concentration sent to offshore from the gas plant shows the Lean MEG weight percentage in total fluid inside the MEG pipeline (corresponding to the parameter QUAL in the equations described with reference to FIG. 6A).

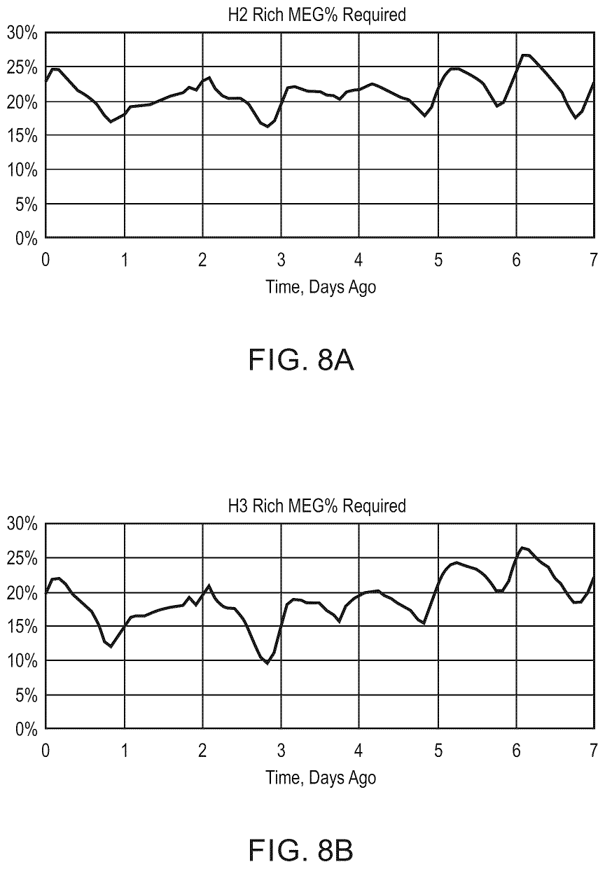

FIG. 8A shows an inhibitor concentration in water arriving to the gas plant from the asset H-2.

FIG. 8B shows an inhibitor concentration required in water arriving to the gas plant from the asset H-3.

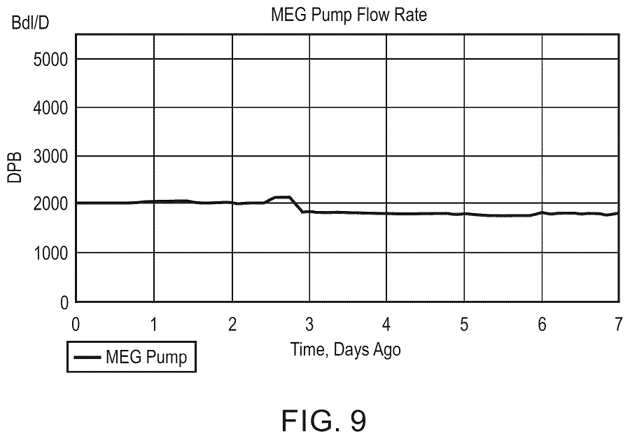

FIG. 9 shows the flow of inhibitor sent from the gas plant to offshore. The flow is shown as an actual measured volumetric pump rate of inhibitor (corresponding to the parameter Q_{Pump} in the equations described with reference to FIG. 6A).

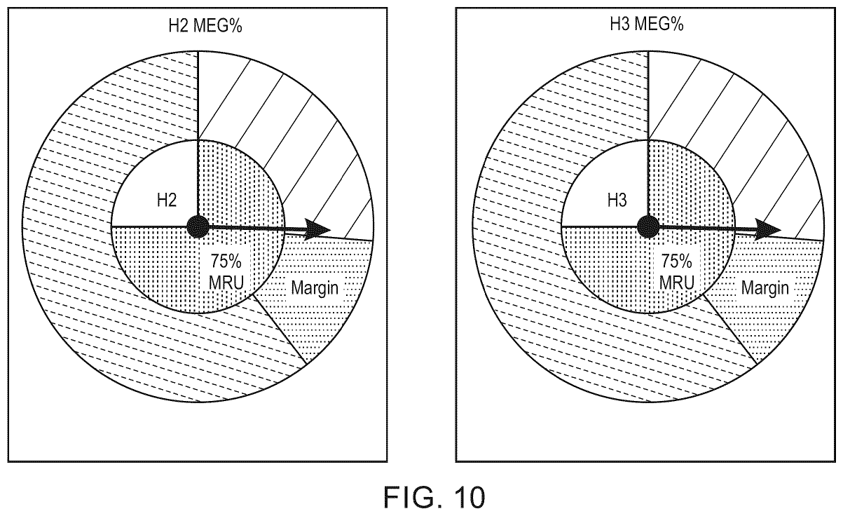

FIG. 10 shows integrated visual indicators of hydrate inhibitor concentration sent from the gas plant to offshore and received at the gas from offshore show the level of optimization. The visual indicators show how close to the minimum acceptable inhibitor concentration the operation is proceeding. The visual indicators are a graphic representation of difference between values from FIGS. 4A and 4B and the concentrations from FIGS. 6A and 6B.

The present techniques track of the weather, flow rates, and thermodynamics of chemical regeneration, encompassing Gas Plant, Chemical pipeline operation, and Produced fluid flowline (trunkline) operation including chemical injection. In embodiments, the present techniques use chemicals with both regenerable (MEG) and once-through (KHI, kinetic hydrate inhibitor). The present techniques integrate of online data from onshore and offshore, advanced laboratory measurements, machine learning methods and overall process system analysis. In some embodiments, thousands of live data inputs are evaluated using online supervised machine learning software. This online software gives instantaneous feedback on the current condition as well as the future projections along with course-correcting recommendations.

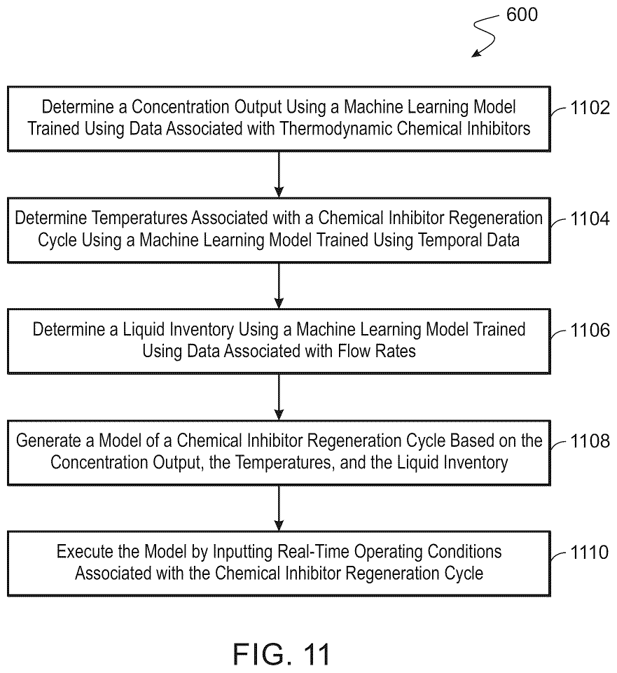

FIG. 11 is a process flow diagram of a process 1100 that enables dynamic digital analysis of chemical inhibitors utilizing machine learning. For convenience, the process 1100 will be described as being performed by a system.

At block 1102, the system determines, using at least one hardware processor, a concentration output using a machine learning model trained using data associated with thermodynamic chemical inhibitors. The data associated with thermodynamic chemical inhibitors can include one or more temperatures, one or more flow rates, pressure data, salinity data, or any combination thereof. The concentration output can define a quality of the thermodynamic chemical inhibitors.

At block 1104, the system determines, using at the least one hardware processor, temperatures associated with a chemical inhibitor regeneration cycle using a machine learning model trained using temporal data. The temporal data can include one or more times of day.

At block 1106, the system determines, using at the least one hardware processor, a liquid inventory using a machine learning model trained using data associated with flow rates; The data associated with flow rates can include a pump flow rate, a flow rate of hydrocarbons, a flow rate of chemical inhibitor, or any combinations thereof.

At block 1108, the system generates, using the at least one hardware processor, a model of a chemical inhibitor regeneration cycle based on the concentration output, the temperatures, and the liquid inventory.

At block 1110, the system executes, using the at least one hardware processor, the model by inputting real-time operating conditions associated with the chemical inhibitor regeneration cycle. The model can output chemical inhibitor concentrations associated with a production system. The model can also output a quantity of chemical inhibitor present in the production system.

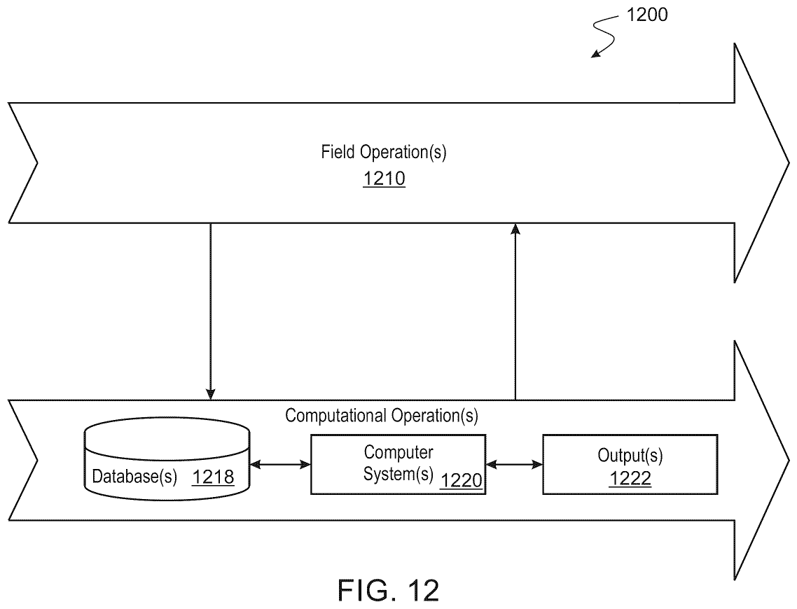

FIG. 12 illustrates hydrocarbon production operations 1200 that include both one or more field operations 1210 and one or more computational operations 1212, which exchange information and control exploration for the production of hydrocarbons. In some implementations, outputs of techniques of the present disclosure can be performed before, during, or in combination with the hydrocarbon production operations 1200, specifically, for example, either as field operations 1210 or computational operations 1212, or both.

Examples of field operations 1210 include forming/drilling a wellbore, hydraulic fracturing, producing through the wellbore, injecting fluids (such as water) through the wellbore, to name a few. In some implementations, methods of the present disclosure can trigger or control the field operations 1210. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1210 and responsively triggering the field operations 1210 including, for example, generating plans and signals that provide feedback to and control physical components of the field operations 1210. Alternatively or in addition, the field operations 1210 can trigger the methods of the present disclosure. For example, implementing physical components (including, for example, hardware, such as sensors) deployed in the field operations 1210 can generate plans and signals that can be provided as input or feedback (or both) to the methods of the present disclosure.

Examples of computational operations 1212 include one or more computer systems 1220 that include one or more processors and computer-readable media (e.g., non-transitory computer-readable media) operatively coupled to the one or more processors to execute computer operations to perform the methods of the present disclosure. The computational operations 1212 can be implemented using one or more databases 1218, which store data received from the field operations 1210 and/or generated internally within the computational operations 1212 (e.g., by implementing the methods of the present disclosure) or both. For example, the one or more computer systems 1220 process inputs from the field operations 1210 to assess conditions in the physical world, the outputs of which are stored in the databases 1218. For example, seismic sensors of the field operations 1210 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1212 where they are stored in the databases 1218 and analyzed by the one or more computer systems 1220.

In some implementations, one or more outputs 1222 generated by the one or more computer systems 1220 can be provided as feedback/input to the field operations 1210 (either as direct input or stored in the databases 1218). The field operations 1210 can use the feedback/input to control physical components used to perform the field operations 1210 in the real world.

For example, the computational operations 1212 can process the seismic data to generate three-dimensional (3D) maps of the subsurface formation. The computational operations 1212 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1212 to process new information about the formation and control the drilling to adjust to the observed conditions in real-time.

The one or more computer systems 1220 can update the 3D maps of the subsurface formation as information from one exploration well is received and the computational operations 1212 can adjust the location of the next exploration well based on the updated 3D maps. Similarly, the data received from production operations can be used by the computational operations 1212 to control components of the production operations. For example, production well and pipeline data can be analyzed to predict slugging in pipelines leading to a refinery and the computational operations 1212 can control machine operated valves upstream of the refinery to reduce the likelihood of plant disruptions that run the risk of taking the plant offline.

In some implementations of the computational operations 1212, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

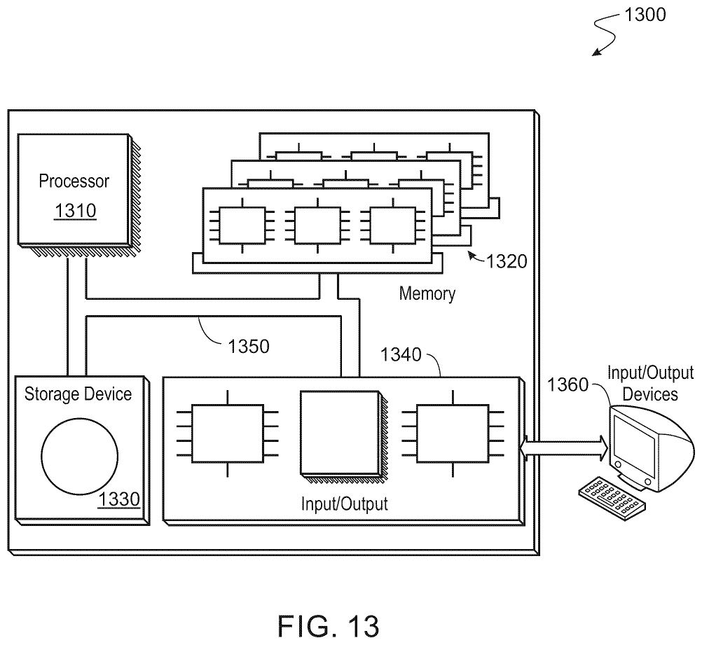

FIG. 13 is a schematic illustration of an example controller 1300 (or control system) for that enables dynamic digital analysis of chemical inhibitors utilizing machine learning. For example, the controller 1300 may be operable according to the production system 100 of FIG. 1 or the process 1210 of FIG. 12. In some embodiments, the controller 1300 is the same as or similar to the computer systems 1220 of FIG. 12. The controller 1300 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1300 includes a processor 1310, a memory 1320, a storage device 1330, and an input/output interface 1340 communicatively coupled with input/output devices 1360 (for example, displays, keyboards, measurement devices, sensors, valves, pumps). Each of the components 1310, 1320, 1330, and 1340 are interconnected using a system bus 1350. The processor 1310 is capable of processing instructions for execution within the controller 1300. The processor may be designed using any of a number of architectures. For example, the processor 1310 may be a CISC (Complex Instruction Set Computers) processor, a RISC (Reduced Instruction Set Computer) processor, or a MISC (Minimal Instruction Set Computer) processor.

In one implementation, the processor 1310 is a single-threaded processor. In another implementation, the processor 1310 is a multi-threaded processor. The processor 1310 is capable of processing instructions stored in the memory 1320 or on the storage device 1330 to display graphical information for a user interface on the input/output interface 1340.

The memory 1320 stores information within the controller 1300. In one implementation, the memory 1320 is a computer-readable medium. In one implementation, the memory 1320 is a volatile memory unit. In another implementation, the memory 1320 is a nonvolatile memory unit.

The storage device 1330 is capable of providing mass storage for the controller 1300. In one implementation, the storage device 1330 is a computer-readable medium. In various different implementations, the storage device 1330 may be a floppy disk device, a hard disk device, an optical disk device, or a tape device.

The input/output interface 1340 provides input/output operations for the controller 1300. In one implementation, the input/output devices 1360 includes a keyboard and/or pointing device. In another implementation, the input/output devices 1360 includes a display unit for displaying graphical user interfaces.

There can be any number of controllers 1300 associated with, or external to, a computer system containing controller 1300, with each controller 1300 communicating over a network. Further, the terms “client,” “user,” and other appropriate terminology can be used interchangeably, as appropriate, without departing from the scope of the present disclosure. Moreover, the present disclosure contemplates that many users can use one controller 1300 and one user can use multiple controllers 1300.

### Embodiments

According to some non-limiting embodiments or examples, provided is a computer-implemented method that enables dynamic digital analysis of chemical inhibitors utilizing machine learning, including: determining, using at least one hardware processor, a concentration output using a machine learning model trained using data associated with thermodynamic chemical inhibitors; determining, using at the least one hardware processor, temperatures associated with a chemical inhibitor regeneration cycle using a machine learning model trained using temporal data; determining, using at the least one hardware processor, a liquid inventory using a machine learning model trained using data associated with flow rates; generating, using the at least one hardware processor, a model of a chemical inhibitor regeneration cycle based on the concentration output, the temperatures, and the liquid inventory; and executing, using the at least one hardware processor, the model by inputting real-time operating conditions associated with the chemical inhibitor regeneration cycle, wherein the model outputs chemical inhibitor concentrations associated with a production system. According to some non-limiting embodiments or examples, provided is an apparatus including a non-transitory, computer readable, storage medium that stores instructions that, when executed by at least one processor, cause the at least one processor to perform operations including: determining a concentration output using a machine learning model trained using data associated with thermodynamic chemical inhibitors; determining temperatures associated with a chemical inhibitor regeneration cycle using a machine learning model trained using temporal data; determining a liquid inventory using a machine learning model trained using data associated with flow rates; generating a model of a chemical inhibitor regeneration cycle based on the concentration output, the temperatures, and the liquid inventory; and executing the model by inputting real-time operating conditions associated with the chemical inhibitor regeneration cycle, wherein the model outputs chemical inhibitor concentrations associated with a production system. According to some non-limiting embodiments or examples, provided is a system, including: one or more memory modules; one or more hardware processors communicably coupled to the one or more memory modules, the one or more hardware processors configured to execute instructions stored on the one or more memory models to perform operations including: determining a concentration output using a machine learning model trained using data associated with thermodynamic chemical inhibitors; determining temperatures associated with a chemical inhibitor regeneration cycle using a machine learning model trained using temporal data; determining a liquid inventory using a machine learning model trained using data associated with flow rates; generating a model of a chemical inhibitor regeneration cycle based on the concentration output, the temperatures, and the liquid inventory; and executing the model by inputting real-time operating conditions associated with the chemical inhibitor regeneration cycle, wherein the model outputs chemical inhibitor concentrations associated with a production system.

Further non-limiting aspects or embodiments are set forth in the following numbered embodiments:

Embodiment 1: A computer-implemented method that enables dynamic digital analysis of chemical inhibitors utilizing machine learning, including: determining, using at least one hardware processor, a concentration output using a machine learning model trained using data associated with thermodynamic chemical inhibitors; determining, using at the least one hardware processor, temperatures associated with a chemical inhibitor regeneration cycle using a machine learning model trained using temporal data; determining, using at the least one hardware processor, a liquid inventory using a machine learning model trained using data associated with flow rates; generating, using the at least one hardware processor, a model of a chemical inhibitor regeneration cycle based on the concentration output, the temperatures, and the liquid inventory; and executing, using the at least one hardware processor, the model by inputting real-time operating conditions associated with the chemical inhibitor regeneration cycle, wherein the model outputs chemical inhibitor concentrations associated with a production system.

Embodiment 2: The computer implemented method of any preceding embodiments, wherein the data associated with thermodynamic chemical inhibitors includes (i) one or more temperatures, (ii) one or more flow rates, (iii) pressure data, (iv) salinity data, or any combination thereof.

Embodiment 3: The computer implemented method of any preceding embodiments, wherein the temporal data includes at least one time of day.

Embodiment 4: The computer implemented method of any preceding embodiments, wherein the data associated with flow rates includes a pump flow rate, a flow rate of hydrocarbons, a flow rate of chemical inhibitor, or any combinations thereof.

Embodiment 5: The computer implemented method of any preceding embodiments, wherein the concentration output defines a quality of the thermodynamic chemical inhibitors.

Embodiment 6: The computer implemented method of any preceding embodiments, wherein the model outputs a quantity of chemical inhibitor present in the production system.

Embodiment 7: An apparatus including a non-transitory, computer readable, storage medium that stores instructions that, when executed by at least one processor, cause the at least one processor to perform operations including: determining a concentration output using a machine learning model trained using data associated with thermodynamic chemical inhibitors; determining temperatures associated with a chemical inhibitor regeneration cycle using a machine learning model trained using temporal data; determining a liquid inventory using a machine learning model trained using data associated with flow rates; generating a model of a chemical inhibitor regeneration cycle based on the concentration output, the temperatures, and the liquid inventory; and executing the model by inputting real-time operating conditions associated with the chemical inhibitor regeneration cycle, wherein the model outputs chemical inhibitor concentrations associated with a production system.

Embodiment 8: The apparatus of any preceding embodiments, wherein the data associated with thermodynamic chemical inhibitors includes (i) one or more temperatures, (ii) one or more flow rates, (iii) pressure data, (iv) salinity data, or any combination thereof.

Embodiment 9: The apparatus of any preceding embodiments, wherein the temporal data includes at least one time of day.

Embodiment 10: The apparatus of any preceding embodiments, wherein the data associated with flow rates includes a pump flow rate, a flow rate of hydrocarbons, a flow rate of chemical inhibitor, or any combinations thereof.

Embodiment 11: The apparatus of any preceding embodiments, wherein the concentration output defines a quality of the thermodynamic chemical inhibitors.

Embodiment 12: The apparatus of any preceding embodiments, wherein the model outputs a quantity of chemical inhibitor present in the production system.

Embodiment 13: A system, including: one or more memory modules; one or more hardware processors communicably coupled to the one or more memory modules, the one or more hardware processors configured to execute instructions stored on the one or more memory models to perform operations including: determining a concentration output using a machine learning model trained using data associated with thermodynamic chemical inhibitors; determining temperatures associated with a chemical inhibitor regeneration cycle using a machine learning model trained using temporal data; determining a liquid inventory using a machine learning model trained using data associated with flow rates; generating a model of a chemical inhibitor regeneration cycle based on the concentration output, the temperatures, and the liquid inventory; and executing the model by inputting real-time operating conditions associated with the chemical inhibitor regeneration cycle, wherein the model outputs chemical inhibitor concentrations associated with a production system.

Embodiment 14: The system of any preceding embodiments, wherein the data associated with thermodynamic chemical inhibitors includes (i) one or more temperatures, (ii) one or more flow rates, (iii) pressure data, (iv) salinity data, or any combination thereof.

Embodiment 15: The system of any preceding embodiments, wherein the temporal data includes at least one time of day.

Embodiment 16: The system of any preceding embodiments, wherein the data associated with flow rates includes a pump flow rate, a flow rate of hydrocarbons, a flow rate of chemical inhibitor, or any combinations thereof.

Embodiment 17: The system of any preceding embodiments, wherein the concentration output defines a quality of the thermodynamic chemical inhibitors.

Embodiment 18: The system of any preceding embodiments, wherein the model outputs a quantity of chemical inhibitor present in the production system.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method that enables dynamic digital analysis of chemical inhibitors utilizing machine learning, comprising:
determining, using at least one hardware processor, a concentration output using a machine learning model trained using data associated with thermodynamic chemical inhibitors;
determining, using at the least one hardware processor, temperatures associated with a chemical inhibitor regeneration cycle using a machine learning model trained using temporal data;
determining, using at the least one hardware processor, a liquid inventory using a machine learning model trained using data associated with flow rates;
generating, using the at least one hardware processor, a model of a chemical inhibitor regeneration cycle based on the concentration output, the temperatures, and the liquid inventory; and
executing, using the at least one hardware processor, the model by inputting real-time operating conditions associated with the chemical inhibitor regeneration cycle, wherein the model outputs chemical inhibitor concentrations associated with a production system.

2. The computer implemented method of claim 1, wherein the data associated with thermodynamic chemical inhibitors comprises (i) one or more temperatures, (ii) one or more flow rates, (iii) pressure data, (iv) salinity data, or any combination thereof.

3. The computer implemented method of claim 1, wherein the temporal data comprises at least one time of day.

4. The computer implemented method of claim 1, wherein the data associated with flow rates comprises a pump flow rate, a flow rate of hydrocarbons, a flow rate of chemical inhibitor, or any combinations thereof.

5. The computer implemented method of claim 1, wherein the concentration output defines a quality of the thermodynamic chemical inhibitors.

6. The computer implemented method of claim 1, wherein the model outputs a quantity of chemical inhibitor present in the production system.

7. An apparatus comprising a non-transitory, computer readable, storage medium that stores instructions that, when executed by at least one processor, cause the at least one processor to perform operations comprising:
determining a concentration output using a machine learning model trained using data associated with thermodynamic chemical inhibitors;
determining temperatures associated with a chemical inhibitor regeneration cycle using a machine learning model trained using temporal data;
determining a liquid inventory using a machine learning model trained using data associated with flow rates;
generating a model of a chemical inhibitor regeneration cycle based on the concentration output, the temperatures, and the liquid inventory; and
executing the model by inputting real-time operating conditions associated with the chemical inhibitor regeneration cycle, wherein the model outputs chemical inhibitor concentrations associated with a production system.

8. The apparatus of claim 7, wherein the data associated with thermodynamic chemical inhibitors comprises (i) one or more temperatures, (ii) one or more flow rates, (iii) pressure data, (iv) salinity data, or any combination thereof.

9. The apparatus of claim 7, wherein the temporal data comprises at least one time of day.

10. The apparatus of claim 7, wherein the data associated with flow rates comprises a pump flow rate, a flow rate of hydrocarbons, a flow rate of chemical inhibitor, or any combinations thereof.

11. The apparatus of claim 7, wherein the concentration output defines a quality of the thermodynamic chemical inhibitors.

12. The apparatus of claim 7, wherein the model outputs a quantity of chemical inhibitor present in the production system.

13. A system, comprising:
one or more memory modules;
one or more hardware processors communicably coupled to the one or more memory modules, the one or more hardware processors configured to execute instructions stored on the one or more memory models to perform operations comprising:
determining a concentration output using a machine learning model trained using data associated with thermodynamic chemical inhibitors;
determining temperatures associated with a chemical inhibitor regeneration cycle using a machine learning model trained using temporal data;
determining a liquid inventory using a machine learning model trained using data associated with flow rates;
generating a model of a chemical inhibitor regeneration cycle based on the concentration output, the temperatures, and the liquid inventory; and
executing the model by inputting real-time operating conditions associated with the chemical inhibitor regeneration cycle, wherein the model outputs chemical inhibitor concentrations associated with a production system.

14. The system of claim 13, wherein the data associated with thermodynamic chemical inhibitors comprises (i) one or more temperatures, (ii) one or more flow rates, (iii) pressure data, (iv) salinity data, or any combination thereof.

15. The system of claim 13, wherein the temporal data comprises at least one time of day.

16. The system of claim 13, wherein the data associated with flow rates comprises a pump flow rate, a flow rate of hydrocarbons, a flow rate of chemical inhibitor, or any combinations thereof.

17. The system of claim 13, wherein the concentration output defines a quality of the thermodynamic chemical inhibitors.

18. The system of claim 13, wherein the model outputs a quantity of chemical inhibitor present in the production system.
